(19) United States
(12) Patent Application Publication
(10) Pub. No.: US 2022/0353385 A1
(43) Pub. Date: Nov. 3, 2022

(54) SCAN REQUEST COMPRISING CONTACT IDENTIFIERS

(71) Applicant: Hewlett-Packard Development Company, L.P., Spring, TX (US)

(72) Inventors: Shakti Amarendra, Bangalore (IN); Sharanabasappa, Bangalore (IN); Vasu Agrawal, Bangalore (IN); Anusha Ghali, Bangalore (IN); Balaji Yalamarthi, Bangalore (IN)

(73) Assignee: Hewlett-Packard Development Company, L.P., Spring, TX (US)

(21) Appl. No.: 17/267,229

(22) PCT Filed: Sep. 16, 2019
(86) PCT No.: PCT/US2019/051309

§ 371 Date: Feb. 9, 2021

(30) Foreign Application Priority Data
Nov. 13, 2018 (IN) 201841042703

(51) Int. Cl. H04N 1/44; G06F 21/60

(52) U.S. Cl. CPC H04N 1/4413; G06F 21/608; H04N 1/4433

(57) ABSTRACT

Techniques for receiving a scan request and creating a proxy scan job by imaging devices are described. According to the present subject matter, a scan request is received from a contact identifier. Further, a proxy scan job corresponding to the scan request is created. Thereafter, a password corresponding to the scan request is generated and transmitted to the contact identifier.

### BACKGROUND

Single-function imaging devices, such as scanners, printers, facsimile devices and photocopying devices are increasingly becoming multi-function devices. For example, a printer implemented as a single-function imaging device may receive a print command from a user and execute the print command to render content on a medium. However, a multi-function printer may incorporate, along with its capability to print content, functionality of a scanner and may accept a scan command from a user to enable generation of an electronic copy of a document. In another example, a scanner may also create a physical copy of a document thereby exhibiting functionalities of a photocopying device.

### BRIEF DESCRIPTION OF FIGURES

The following detailed description references the drawings, wherein:

FIG. 1 illustrates a secure scanning system using an imaging device implemented in a network environment, in accordance with an example of the present subject matter;

FIG. 2 illustrates an imaging device, in accordance with an example of the present subject matter;

FIG. 3 illustrates an imaging device, in accordance with an example of the present subject matter;

FIG. 4 illustrates a method for obtaining a scanned document from an imaging device, in accordance with an example of the present subject matter;

FIG. 5 illustrates a method for scanning a document by an imaging device, in accordance with an example of the present subject matter; and

FIG. 6 illustrates a computing environment implementing a non-transitory computer-readable medium for securing access to a document scanned by an imaging device, according to an example of the present subject matter.

### DETAILED DESCRIPTION

A multi-function imaging device, is a device incorporating multiple functionalities, such as that of a printer, a scanner, a fax and a photocopier. On the other hand, a single-function imaging device may act, for example, as a scanner alone. Multi-function imaging devices and single-function imaging devices are referred to as imaging devices herein.

While implementing multiple functionalities in the imaging devices enhances users' experience, such an implementation may also pose various data security related threats. For instance, a document provided by a user to an imaging device solely for the purposes of scanning, may be maliciously photocopied, for example, by a rogue operator of the imaging device.

Further, the imaging devices may be implemented in a network environment where multiple users connect to an imaging device over the network to use functionalities of the imaging device. Implementing the imaging devices in the network environment, enhances accessibility of the imaging devices by the users and in turn enhances users' experience. For example, a user may provide a command to the imaging device to print a document, through any user device connected to the network, for example, from a remote location. However, such a network implementation may often further amplify data security related threats associated with the imaging devices.

For Instance, consider a situation where an imaging device is used for scan-to-email operation for scanning a document and sending the scanned data to an email address. To send the scanned data to the email address, a user may indicate the email address to the imaging device, for example, by selecting the email address from a list of email addresses registered with the imaging device. In such cases, it is possible, that the user or a rogue operator may, inadvertently or conspicuously, provide a wrong email address, thus resulting in unauthorized dissemination of the scanned data. Furthermore, the scanned data may be disseminated to multiple email addresses. Thus, generally, scan operations by imaging devices may be vulnerable to data security issues.

According to an example of the present subject matter, techniques to secure scan operations by imaging devices implemented in a network environment, for preventing unauthorized dissemination of scanned data, is described. Example techniques described herein enable the imaging devices to provide the scanned data to an authorized user who has requested the scan operation.

According to an example of the present subject matter, a secure scanning system using an imaging device is implemented in a network environment. According to the present subject matter, a user may send a scan request to the imaging device. The scan request comprises a contact identifier of the user. In an example, the contact identifier may be an email address of the user. The imaging device receives the scan request and creates a proxy scan job corresponding to the scan request. The imaging device also generates a password for the proxy scan job and sends the password to the contact identifier of the user. The imaging device executes the proxy scan job to scan a document when the password is provided to the imaging device as a user input. The scanned document is thereafter sent to the contact identifier.

Thus, according to the present subject matter, the imaging device is to perform scan operations based on a scan request associated with a contact identifier of the user and provide the scanned document to the contact identifier, thus eliminating possibility of sharing the scanned document with an unauthorized user.

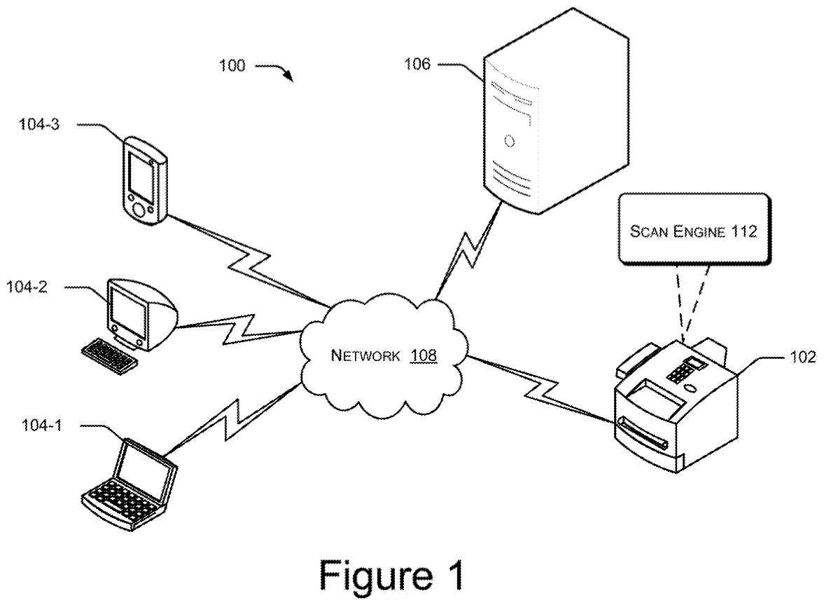

The above techniques are further described with reference to FIG. 1 to FIG. 6. It should be noted that the description and the figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a secure scanning system 100 comprising an imaging device 102 and a plurality of user devices 104-1, 104-2, and 104-3 implemented in a network environment according to an example of the present subject matter. Examples of imaging device 102 include scanners, digital senders, single function printer (SFP), multi-function printer (MFP), photocopiers, etc. In an example, a plurality of imaging device 102 may be present in the network environment, however, for the simplicity, a single imaging device 102 is shown in the figure.

The imaging device 102 may be accessed by the plurality of user devices 104-1, 104-2, and 104-3. Examples of the user devices 104-1, 104-2, 104-3 may include, but are not limited to, electronic devices, such as desktop computers, laptops, smartphones, personal digital assistants (PDAs), and tablets. The plurality of user devices 104-1, 104-2, and 104-3, collectively referred to as user devices 104, may be used to provide a scan request to the imaging device 102 for scanning a document. In an example, a user device, such as the user device 104-1 may be coupled to a plurality of imaging devices and the user may indicate, in the scan request, the imaging device to which he desires to send the scan request.

In an example, the scan request from a user device, such as the user device 104-1 may be provided to the imaging device 102 via a server 106. For example, the user device 104-1 may be a mobile device such as a smartphone or tablets not incorporating a scan driver for generating the scan request in a format that would be understandable or supported by the imaging device 102. In such example implementations, the user device 104-1 may communicate the scan request to the imaging device 102 via the server 106.

In an example, the server 106 may be any server for managing the multiple imaging devices in the network environment. For example, the server may manage the dissemination of a scan request to a designated imaging device. The server 106 may be implemented as a computing device, including, for example, a workstation, a mainframe computer, a desktop, a personal computer, a notebook, a portable computer, and a laptop. Further, in one example, the server 106 may be a distributed system in which different computing devices may host the hardware or software components of the server 106.

In an example, the user device 104-1 may provide the scan request to the server 106 over a network 108 which may in turn transmit the scan request to the imaging device 102 over the second network 108. In an example, the network 108 may be a single network or a combination of multiple networks and may use a variety of different communication protocols. The network 108 may be a wireless or a wired network, or a combination thereof. Examples of such individual networks include, but are not limited to, Global System for Mobile Communication (GSM) network, Universal Mobile telecommunications System (UMTS) network, Personal Communications Service (PCS) network. Time Division Multiple Access (TDMA) network, Code Division Multiple Access (CDMA) network, Next Generation Network (NON), Public Switched Telephone Network (PSTN). Depending on the technology, the network 108 includes various network entities, such as gateways, routers; however, such details have been omitted for sake of brevity of the present description.

The server 106 modifies the scan request received from the user device 104-1 in a format supported by the imaging device 102 and thereafter transmits the scan request to the imaging device 102. In an example, when there is plurality of imaging devices present in the network environment, the server 106 may identify, based on a device identifier included in the scan request received from the user device 104-1, the imaging device 102 to which the scan request is to be transmitted. Further, in an example, the server 106 may decide, based on the pending tasks with each of the imaging devices in the network, an imaging device to which the scan request should be directed. For example, the server 106 may direct the scan request to an imaging device which has relatively less tasks pending in its queue. In another example, the server 106 may direct the scan request to an imaging device which is nearest to the contact identifier of the user.

The scan request may, for example, be understood as a command provided to the imaging device 102 for scanning a document comprising a single or multiple pages. The scan request may comprise instructions relating to the scanning operations. The instructions may indicate to the imaging device 102 a resolution for scanning the document, a mode, such as monotone or color mode of scanning and so on.

Further, the scan request comprises a contact identifier associated with a user of the user device 104-1. The contact identifier associated with the user may be an email address, a mobile number, a fax number or any other contact number or address which may be used to communicate with the user.

Upon receiving the scan request, the imaging device 102 creates a proxy scan job corresponding to the scan request. The proxy scan job may be understood as an executable task which when executed performs a scanning operation on the imaging device 102. The proxy scan job is stored in the imaging device 102 and may be executed and may be queued with the pending tasks of the imaging device 102. The proxy scan job may be executed at a later point of time when initiated by a user. Further, the imaging device 102 generates a password corresponding to the proxy scan job.

The imaging device 102 transmits the password to the contact identifier of the user. The proxy scan job, stored in the imaging device 102, may be executed by a scan engine 112 of the imaging device 102 when the password is provided to the imaging device 102 as a user input. Execution of the proxy scan job causes a document, kept on a scanner bed of the imaging device 102, to be scanned. The scanned document is thereafter transmitted to the contact identifier via the server 106 over the network 108.

Thus, according to the present subject matter a scanning operation is executed for the scan request received by the imaging device 102. In one example, scan requests received from authorized sources alone may be processed. For example, a list of authorized contact identifiers may be defined for the imaging device 102. A scan request associated with a contact identifier that is not present in the list of authorized contact identifier may be discarded by the imaging device 102 and may not be processed further for creation of a corresponding proxy scan job.

Further, the imaging device 102 executes the proxy scan job upon receiving the password corresponding to the scan request. This allows users flexibility for controlling execution of scan jobs. For instance, in cases where a user is remotely located, and is unable to access the imaging device 102 to execute the proxy scan job, he may share the password with another user who can access the imaging device. The other user may execute the proxy scan job on the behalf of the user by entering the password into the imaging device 102. As a result of such an execution, the scan data generated corresponding to the scanned document, interchangeably referred to as scanned document herein, is transmitted to the user initiating the scan request.

Since the imaging device 102 sends the scanned data to the contact identifier from which the scan request is received, it would not be possible for the person who may have entered the password or any other unauthorized person to receive the scanned data. Further, since the user does not specify an address, such as email address to the imaging device 102 for delivering the scanned document and scanned document is transmitted to the contact identifier received with the scan request, errors due to inadvertently providing incorrect email addresses to the imaging device 102 are eliminated.

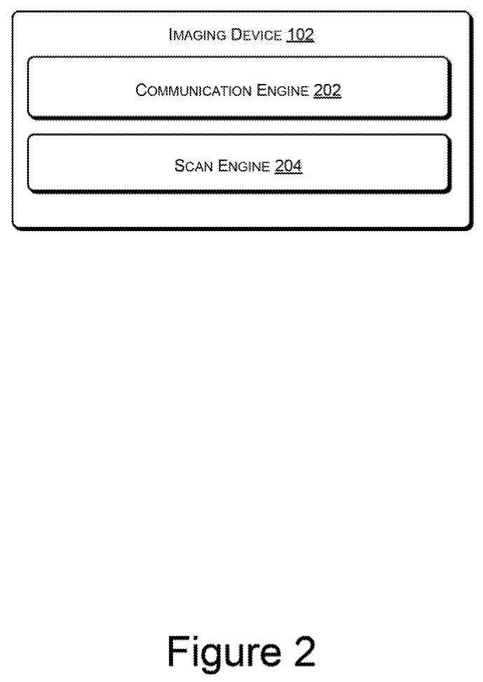

FIG. 2 shows the imaging device 102, according to an example of the present subject matter.

According to an example of the present subject matter, the imaging device 102 comprises a communication engine 202 and the scan engine 204. The scan engine 204 may be similar to the scan engine 112. The communication engine 202 receives a scan request from a user device, such as the user device 104-1. As mentioned previously, the scan request comprises a user identifier of the user. The communication engine 202 creates a proxy scan job corresponding to the scan request. In an example, the proxy scan job is assigned a scan job identifier. The scan job identifier may, in an example, uniquely identify each of the multiple proxy scan jobs created corresponding to the multiple scan requests received by the communication engine 202 from the user device 104-1.

Further to creation of the proxy scan job, the communication engine 202 generates a password associated with the scan job identifier. The communication engine 202 provides the scan job identifier to the contact identifier included in the scan request. The communication engine 202 further causes the password to be sent, either together with the scan job identifier or at different instance of time, to the contact identifier included in the scan request.

The scan engine 112 of the imaging device 102 is to execute the proxy scan job to scan a document when the password is received as a user input. In an example, the user may select the proxy scan job based on the scan job identifier and may provide the corresponding password to the imaging device 102, for instance, when prompted by the imaging device 102 based on the user's action of selecting the proxy scan job based on the scan job identifier. After the scan operation is completed, the scan engine 204 causes the scanned document to be transmitted to the contact identifier.

In another example implementation, while the communication engine 202 may create a proxy scan job corresponding to the scan request and assign a scan job identifier at the time of receipt of the scan request, the communication engine 202 may delay the generation of the password corresponding to the scan job. Alternatively, in an example, the password may be generated upon the receipt of the scan request, however, the password may be temporarily stored such that the transmission of the password may be delayed. As apparent, in such implementations, the scan job identifier alone may be transmitted to the contact identifier included in the scan request. Subsequently, at a later instance, when a user selects the scan job for execution, for instance, based on the scan job identifier assigned to the job, the password may be transmitted, in response to the selection of the scan job, to the contact identifier included in the scan request.

To explain in other words, the user may select the proxy scan job through a user interface of the imaging device 102 to indicate to the imaging device 102 that the proxy scan job is to be executed. In an implementation, the scan engine 112 of the imaging device 102 may detect the selection of the proxy scan job by the user and may trigger the communication engine 202. In another example, the communication engine 202 may itself detect the selection of the proxy scan job by the user. Based on the selected proxy scan job, in an example, the communication engine 202 generates a password and transmits the same to the contact identifier associated with the scan request that resulted in creation of the selected proxy scan job. In another example, if the password was generated at the time of receipt of the scan request and stored for delayed transmission, the same may be retrieved by the communication engine 202 and transmitted to the contact identifier.

Thereafter, as mentioned above, the scan engine 112 of the imaging device 102 executes the proxy scan job to scan a document when the password transmitted to the contact identifier is provided to the imaging device 102 as an input and causes the scanned document to be transmitted to the contact identifier.

The scanned document is thus transmitted to the contact identifier which was received with the scan request. Thus, according to the present subject matter, to receive the scanned document, the process of configuring an email address for the imaging device 102 to deliver the scan data to that email address is eliminated. According to the present subject matter, the scanned document is sent to the contact identifier which is received with the scan request. Thus, additional process of configuring or providing the email address as well as the errors that may result from providing a wrong or unauthorized email for receiving the scanned document are eliminated.

Additionally, the above described implementations also provide for delayed generation and transmission of passwords thereby enabling users to execute proxy scan jobs, corresponding to scan requests that may have been created at a prior instance, without having the users to securely maintain or store the password. The users have the flexibility to receive a password, for example, at an instance when a document to be scanned has been positioned on a scanning bed of the imaging device 102 and execution of the proxy scan job is triggered and thus have enhanced user experience.

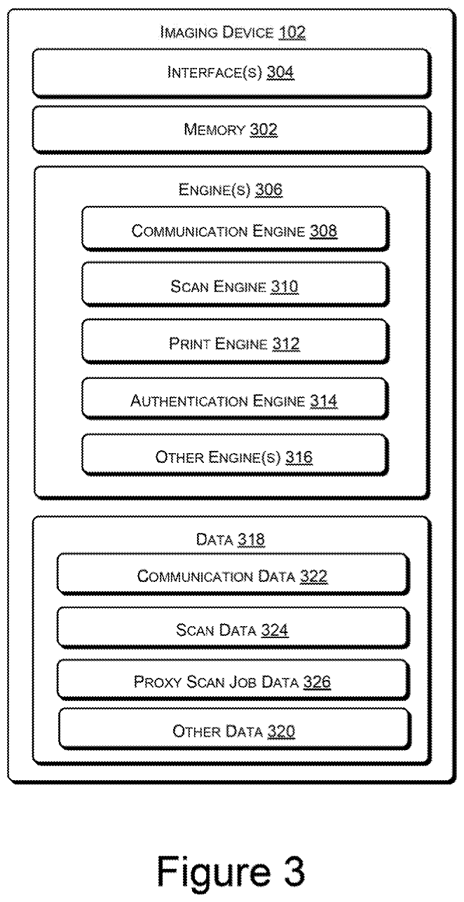

FIG. 3 illustrates an imaging device 102, in accordance with another example of the present subject matter.

The imaging device 102, among other things, includes and a memory 302, interface(s) 304, and engine(s) 306. The memory 302 may include any computer-readable medium including, for example, volatile memory (e.g., RAM), and/or non-volatile memory (e.g., EPROM, flash memory, etc.). The interface 304 may include a variety of software and hardware interfaces that allow the imaging device 102 to interact with other devices, such as the user devices 104-1, 104-2, and 104-3 or other input/output (I/O) devices that may be used to provide inputs, such as, passwords, selection of proxy scan job to imaging device 102.

The engine(s) 306 may be implemented as a combination of hardware and programming (for example, programmable instructions) to implement certain functionalities of the engine(s) 306, such as creating proxy scan jobs, transmitting passwords and executing instructions in response to receiving the password. In examples described herein, such combinations of hardware and programming may be implemented in several different ways. For example, the programming for the engine(s) 306 may be processor executable instructions stored on a non-transitory machine-readable storage medium and the hardware for the engine(s) 306 may include a processing resource (for example, implemented as either a single processor or a combination of multiple processors), to execute such instructions. In the present examples, the machine-readable storage medium may store instructions that, when executed by the processing resource, implement engine(s) 306.

In such examples, the imaging device 102 may include the machine-readable storage medium storing the instructions and the processing resource to execute the instructions, or the machine-readable storage medium may be separate but accessible to the imaging device 102 and the processing resource. In other examples, engine(s) 306 may be implemented by electronic circuitry. The engine(s) 306 may include a communication engine 308, a scan engine 310, a print engine 312, and an authentication engine 314. The communication engine 308 may be similar to the communication engine 202 and the scan engine 310 may be similar to the scan engine 112. In an example, the engine(s) 306 may also comprise other engine(s) 306 that supplement functions of the image imaging device 102.

Data 318 serves, amongst other things, as a repository for storing data that may be fetched, processed, received, or generated by the engine(s) 306. The data 318 comprises other data 320 corresponding to the other engine(s) 306. In the illustrated example, the data 318 of the imaging device 102 also comprises communication data 322, scan data 324, and proxy scan job data 326. The other data 320 may store the data pertaining to the other engine(s) 306.

In operation, the communication engine 308 receives a scan request from a server, such as the server 106. In an example, the scan request received by the communication engine 308 may be an email from the server 106. As mentioned previously, the scan request, i.e., the email from the server 106 in the present example, comprises a contact identifier of a user initiating the scan request. Again, as mentioned previously, in an example, the contact identifier may be the email address of the user. The contact identifier may be stored in the communication data 322.

In an example, the scan request is an email directed to an email address associated with the scan engine 310 of the imaging device 102. In an example, the imaging device 102 may be a multifunction peripheral (MFP) having different email addresses associated with each of its peripherals, such as a scanner peripheral or the scan engine 310 and a printer peripheral or print engine 312. For example, the imaging device 102 may have an email address, for example, print123@domainname.com for the printer peripheral or the print engine 312. A user may send a print request in the form of an email to the email address of the print engine 312. Further, the imaging device 102 may have another email address, for example, scan123@domainname.com for the scan engine 310. To send a scan request to the imaging device 102, a user may send an email to the email address of the scan engine 310 of the imaging device 102. Thus, the imaging device 102 may determine a request received as an email to be a scan request or a print request based on email address at which the request is received.

In another example, a common email address, say imagingdeviceID@domainname.com may be used by the different peripheral of the imaging device 102 for receiving requests relating to different functionalities of the imaging device 102. In an example, a user may send a request for a printing operation or a scanning operation on the email address of the imaging device 102. In an example, a scan request may be an email directed to the email, imagingdeviceID@domanname.com, of the imaging device 102. According to the present subject matter, the email may include an indicator which is indicative of a scan job. For example, the email may comprise a read receipt as an indicator. The read receipt may be detected by the communication engine 308 to determine that the email is a scan request for performing a scanning operation.

The indicator, i.e., the read receipt in the present example, may be used to distinguish a scan request from other types of requests that may be received by the imaging device 102 without having to create a dedicated email addresses for the scanner peripheral or the scan engine 310 of the imaging device 102. Accordingly, an email with a read receipt may be construed as a scan request as opposed to an email without a read receipt that may be construed as a print request, for instance.

Once the scan request is received at the imaging device 102, the authentication engine 314 may determine, based on the contact identifier associated with the scan request, whether the imaging device 102 is authorized to accept the scan request. As explained previously, the scan request may be an email from the server 106 and may comprise a contact identifier, such as an email address or contact number of a user initiating the scan request. The imaging device 102 may be authorized to accept the scan requests from some contact identifiers alone and may thus make a determination if the instant scan request may be accepted or not.

In an example implementation, the imaging device 102 may store a list of authorized contact identifiers. In an example, the list of authorized contact identifiers may be stored in the communication data 322. The authentication engine 314 may compare the contact identifier received with the scan request with the list of authorized contact identifiers. As explained earlier, the contact identifier received with the scan request may also be stored in the communication data 322. To determine if the contact identifier is authorized for sending the scan request, the authentication engine 314 may retrieve the contact identifier from the communication data 322 and may compare the retrieved contact identifier with the list of authorized contact identifiers. If the retrieved contact identifier matches with a contact identifier in the list of authorized contact identifiers, the authentication engine 314 may determine that the imaging device 102 is authorized to accept the scan request.

Considering an example where the contact identifier received with the scan request is an email address, xyz@domainname.com, the authentication engine 314 may determine whether the email address, xyz@domainname.com, is present in the list of authorized contact identifiers. If the email address, xyz@domainnname.com, received with the scan request, matches with an email address in the list of authorized contact identifiers, the authentication engine 314 may determine that the imaging device 102 is authorized to accept the scan request. If the email address, xyz@domainnname.com, received with the scan request, does not match with an email address in the list of authorized contact identifiers, the authentication engine 314 may determine that the imaging device 102 is not authorized to accept the scan request and the scan request may be discarded. In an example, the list of authorized contact identifiers may be defined based on the domain name. Referring to the above example, if a domain name, such as domainname.com is authorized, a scan request originating from an email address associated with such an authorized domain name is acceptable.

When it is determined that the scan request is acceptable or, in other words, the imaging device 102 is authorized to cater to the scan request, the communication engine 308 creates a proxy scan job corresponding to the scan request. The proxy scan job is stored in the proxy scan job data 326. The proxy scan job is an executable command which when executed performs a scanning operation to scan a document that may be placed on a scanning bed to the imaging device 102.

Further, communication engine 308 may assign a scan job identifier to the proxy scan job. For example, the communication engine 308 may receive the scan request from a contact identifier, xyz@domainname.com and after it is determined that the contact identifier is authorized, the communication engine 308 may create a proxy scan job. Further, the communication engine 308 may assign a scan job identifier, ‘xyz-scan’ to the proxy scan job. The scan job identifier ‘xyz-scan’ may be saved in the proxy scan job data 326.

After the proxy scan job is created, the communication engine 308 generates a password associated with the scan job identifier. The password may be composed of numerals, characters, special characters or a combination thereof. In an example, the password may also be stored in proxy scan job data 326 in association with the corresponding proxy scan job. The communication engine 308 further sends the password and the scan job identifier to the contact identifier, for example via the interface(s) 304 of the imaging device 102. For example, where the contact identifier is an email address, the password and the scan job identifier are transmitted to the email address, likewise, if the contact identifier is a mobile number the password and the scan job identifier may be transmitted to the mobile number and so on.

For example, considering the above example, the communication engine 308 may generate a password ‘xyz@123’ for the scan job identifier ‘xyz-scan’. The communication engine 308 may send the password, ‘xyz@123’ and the scan job identifier ‘xyz-scan’ to the contact identifier of the user. The user may access the password, ‘xyz@123’, and the scan job identifier, ‘xyz-scan’, on his contact identifier.

The imaging device 102 may receive multiple scan requests and may create a proxy scan job corresponding to each scan request. The multiple proxy scan jobs may be queued by the imaging device 102 for execution. For example, the imaging device 102 may display the proxy scan jobs, for example, as a list or a queue. In an example, in the displayed list, the proxy scan jobs may be listed against their corresponding contact identifier. In another example, the imaging device 102 may display the scan job identifiers created for each of the multiple scan requests received at the imaging device 102, such that, a proxy scan job may be selected based on its corresponding scan job identifier for execution.

In an example, for executing a scan job, the user may select the proxy scan job, for example, based on the corresponding scan job identifier that is communicated to the user via his contact identifier. In an example, the scan engine 310 of the imaging device 102 may allow selection of a proxy scan job based on the corresponding proxy scan job identifier. In an example, any other user, on the behest of the user, may also select the scan job identifier. For example, when the user is at a remote location such that he cannot access the imaging device 102, the user may ask the other user, who may be in the vicinity of the imaging device 102, to execute the proxy scan job on behalf of the user. In such cases, the user may share the scan job identifier and the password, which he has received on his contact identifier as a result of initiation of the scan request, with the other user.

Upon selection of the proxy scan job identifier, the imaging device 102 may prompt the user to provide the password. The user may provide the password for the corresponding scan job identifier to the imaging device 102. The authentication engine 314 may receive the password and may thereafter authenticate the received password. The received password is authenticated if it is same as the password sent to the contact identifier for the selected scan job identifier. The authentication engine 314 compares the received password with the password stored in the proxy scan job data 326 for the selected scan job identifier. If the received password matches with the password stored in the proxy scan job data 326 for the selected scan job identifier, the authentication is successful.

In case when the authentication is unsuccessful, due to incorrect password or incorrect combination of selected scan job identifier and the corresponding password, the scan engine 310 does not execute the proxy scan job corresponding to the selected scan job identifier. However, if the authentication engine 314 successfully authenticates the password, the scan engine 310 executes the proxy scan job to scan a document kept on a scanner bed of the imaging device 102. In an example, the user may keep the document on the scanner bed prior to selecting the scan job identifier and then providing the password. The scanned document may be stored in the scan data 324. The scan engine 310 may retrieve the scanned document stored in the scan data 324 and transmit the same to the contact identifier of the user. In an example, once the scan engine 310 has transmitted the scanned document, the scanned document stored in the scan data 324 is deleted.

In an example, the imaging device 102 may comprise a print engine 312 to print the scanned document upon being instructed by the user by way of a print command or a command to generate a photocopy of the document being scanned. Upon user's command, the print engine 312 may retrieve the scanned document from the scan data 324 and may thereafter print the scanned document. While printing the scanned document, the print engine 312 may insert an indication of the contact identifier, received with the scan request, in the printed document. In an example, the indication may be included in the footnote of the document. In an example, considering that the scan request comprises a contact identifier, abc@domainname.com, while printing of the scanned document generated corresponding to the scan request, the print engine 312 may include a footnote: ‘scanned document transmitted to abc@domainname.com’ in the printed document.

In an example, including the indication of contact identifier in the printed document may alert a user about any scanning operation which may have been performed on a document being photocopied. Consider a scenario where an above described imaging device is being used as a photocopier, by an operator, for photocopying documents of customers. For photocopying, the imaging device scans the document and thereafter prints it. A customer may provide the operator, a document for photocopying. The operator may, by using the method as described above, execute a proxy scan job initiated by him in parallel to the photocopying operation and may transmit the scanned the document to a contact identifier, such as his email address. According to the present subject matter, when the operator performs the scan operation along with the photocopying, an indication is included in the printed document which indicates that a scanning operation has been performed on the document and the scanned data is has been transmitted to third party. This may alert the customer that the operator is involved in malpractices.

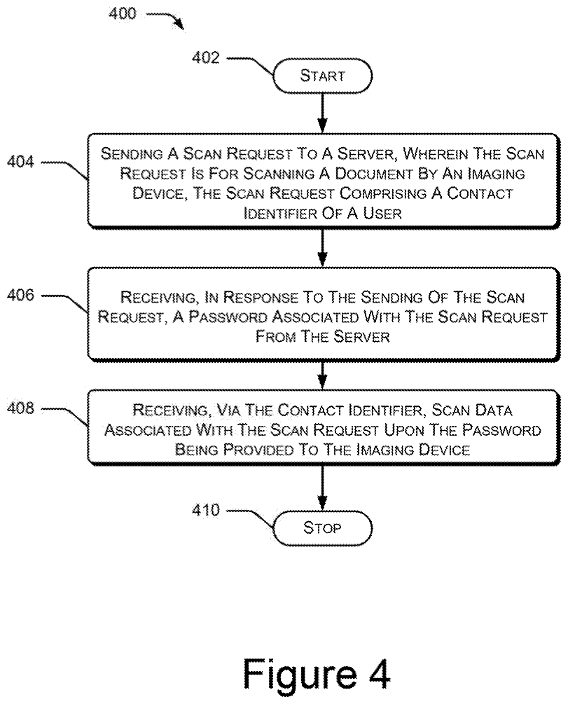

FIG. 4 illustrates a method 400 for obtaining a scanned document from an imaging device, according to an example of the present subject matter. Although the method 400 and may be implemented in a variety of user devices, for the ease of explanation, the present description of the example method 400 is provided in reference to the above-described user device 104-1 implemented in the secure scanning system implemented in the network environment.

The order in which the method 400 is described is not intended to be construed as a limitation, and any number of the described method blocks may be combined in any order to implement the method 400, or an alternative method.

It may be understood that blocks of the method 400 may be performed by the user device 104-1. The blocks of the method 400 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 4, The method starts at block 402 and proceeds to block 404. At block 404, a user device, such as the user device 104-1 sends a scan request to a sever, such as the server 106. As explained earlier, the scan request can be understood as a command for scanning a document. The scan request may include details like number of pages for scanning, single side/double side scanning, monotone or colored scanning, image quality, such as high image resolution or medium image resolution and so on. The scan request comprises a contact identifier, such as email address, a mobile number of a user. Through the server 106, the scan request is eventually transmitted to an imaging device, such as the imaging device 102. As explained in the foregoing description, based on receipt of the scan request the imaging device 102 generates a password and transmits the same to the contact identifier.

At block 406, the user device 104-1 receives a password associated with the scan request, in response to sending the scan request. At block 408, the user device 104-1 receives scan data corresponding to the scan request upon the password being provided to the imaging device 102. For receiving the scan data, the password may be manually fed into the imaging device 102, which performs the scanning operation upon verification of the password. The method, thereafter, stops at block 410.

Thus, according to the present subject matter the scanned document is delivered to the contact identifier received with the scan request. This makes the scanning operation secure from any unauthorized tapping of the scanned document.

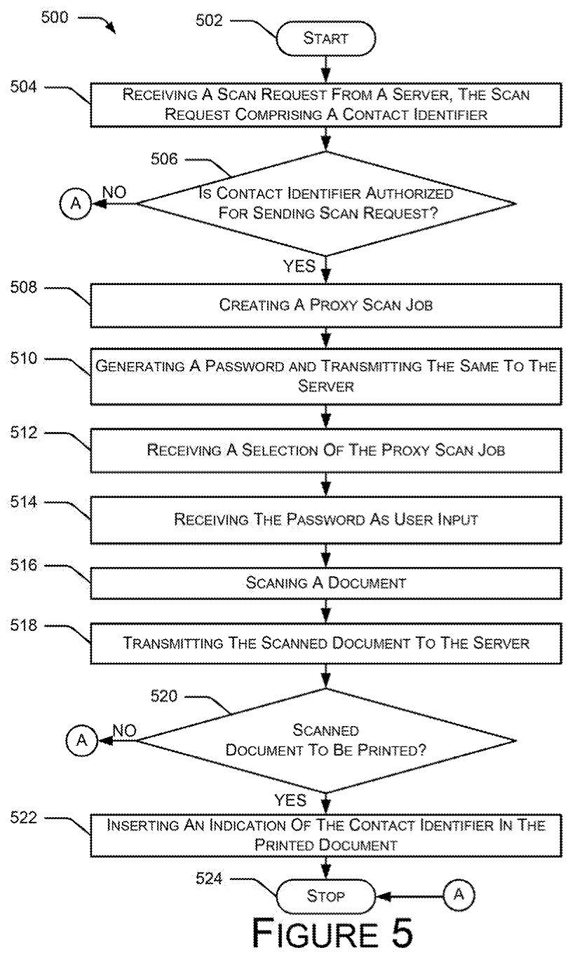

FIG. 5 illustrates a method 500 for scanning a document by an imaging device, according to an example of the present subject matter. Although the method 500 and may be implemented in a variety of imaging device, for the ease of explanation, the present description of the example method 500 to scan the document is provided in reference to the above-described imaging device 102.

The order in which the method 500 is described is not intended to be construed as a limitation, and any number of the described method blocks may be combined in any order to implement the method 500, or an alternative method.

It may be understood that blocks of the method 500 may be performed by the imaging device 102. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

The method starts at block 502 and proceeds to block 504. At block 504, a scan request is received by imaging device 102. The scan request is received by the imaging device 102 from a server, such as the server 106 which in turn may have received the scan request from a user device, such as user device 104-1. In an example, the scan request may be an email. The email may comprise a read receipt which may indicate to the imaging device 102 that the email is a scan request. As explained earlier, the scan request comprises a contact identifier, such as email address, mobile number, fax number of the user.

At block 506, the imaging device 102 determines if the contact identifier is authorized for sending the scan request. In an example, an authentication engine, such as the authentication engine 314, may determine if the contact identifier is authorized to send a scan request to the imaging device 102. The imaging device 102 may access a list of authorized contact identifiers and based on a comparison between the received contact identifier and the list of authorized contact identifiers, the imaging device 102 may determine if the received contact identifier is authorized or not. If it is determined that the received contact identifier is not authorized, the scan request is discarded, and the method stops at block 524. If it is determined that the received contact identifier if authorized, the method proceeds to block 508.

At block 508, imaging device creates a proxy scan job corresponding to the scan request received at block 504. The method further proceeds to block 510, where a password corresponding to the created proxy scan job is generated and transmitted to the server. The server further transmits the password to the user. In an example implementation, as explained previously, while the proxy scan job corresponding to the scan request received at block 504 may be created at the time of receipt of the scan request, the generation of the password corresponding to the scan job may be reserved for a later instance of time.

At block 512 the imaging device 102 receives a selection of the proxy scan job. A user may select the proxy scan job through an user interface of the imaging device 102 to indicate to the imaging device 102 that the proxy scan job is to executed. At block 514, the imaging device 102 receives the password as a user input which may be entered into the imaging device 102 via the user interface. In an example, in response to the receiving selection of the scan job identifier, the imaging device 102 may provide a prompt for the user to provide the password. The user may thereafter provide the password to the imaging device 102.

At block 516, upon receiving the password, the imaging device 102 executes the proxy scan job to scan a document. In an example, the proxy scan job is executed after successful authentication of the password provided by the user. If the user inputs an incorrect password, i.e., a password other than the password which is transmitted to the contact identifier, the authentication is unsuccessful, and the proxy scan job is not executed.

At block 518, the scanned document is transmitted to the contact identifier of the user. For example, if the contact identifier is an email address, the scanned document is sent as an email to the email address. Further, in a case the contact identifier is a mobile number, the scanned document may be sent to the mobile number, may be as a multimedia message.

Thereafter, the method proceeds to the decision block 520 where it is determined if the scanned data is to be printed. In an example, the user may provide an instruction to print the scanned data. If the determination made at block 520 is negative, the method proceeds to block 524 and stops.

However, if it is determined that scanned document is to be printed, the method proceeds to block 522 and an indication of the contact identifier is included in the printed document. Thereafter, method proceeds to block 524 and terminates.

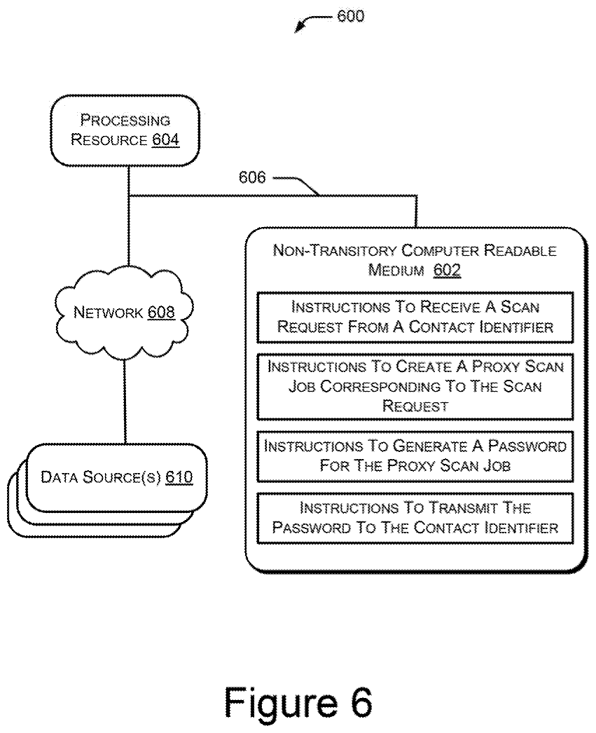

FIG. 6 illustrates a computing environment implementing a non-transitory computer-readable medium for securing access to a document scanned by an imaging device, according to an example. In an example, the computing environment 600 may comprise an imaging device, such as imaging device 102. The computing environment 600 includes a processing resource 604 communicatively coupled to the non-transitory computer-readable medium 602 through a communication link 606. In an example, the processing resource 604 may be a processor of the imaging device that fetches and executes computer-readable instructions from the non-transitory computer-readable medium 602.

The non-transitory computer-readable medium 602 can be, for example, an internal memory device or an external memory device. In an example, the communication link 606 may be a direct communication link, such as any memory read/write interface. In another example, the communication link 606 may be an indirect communication link, such as a network interface. In such a case, the processing resource 604 can access the non-transitory computer-readable medium 602 through a network 608. The network 608 may be a single network or a combination of multiple networks and may use a variety of different communication protocols.

The processing resource 604 and the non-transitory computer-readable medium 602 may also be communicatively coupled to data sources 610. The data source(s) 610 may be used to store details, such as contact identifier, proxy scan job, scan job identifier, password in an example. In an example, the non-transitory computer-readable medium 602 comprises executable instructions 612 scanning and transmitting the scanned document. For example, the non-transitory computer-readable medium 602 may comprise instructions executable to implement the previously described communication engine 202 and scan engine 112.

In an example, the instructions 612 may cause the processing resource 604 to receive, at an imaging device, a scan request from a contact identifier. As apparent from the previous description, the scan request is a command for executing a scanning operation at the imaging device. In an example, the scan request may be received from the contact identifier of a user. In an example, the contact identifier may be an email address, a mobile number, a fax number. Further, the instructions 612 may cause the processing resource 604 to create a proxy scan job. The proxy scan job may be understood as the executable commands which can be executed to perform a scanning operation.

The instructions 612 may further cause the processing resource 604 to generate a password for the proxy scan job and associate the password with the corresponding proxy scan job. The instruction 612 further causes the password to be transmitted to the contact identifier.

Further, the instruction 612 may cause the processing resource 604 to allow selection the proxy scan job. In response to the selection, the instruction 612 may, thereafter, cause the processing resource 604 to provide a prompt to the user to provide the password. After the password is provided to the imaging device, the instruction 612 may cause the processing resource 604 to compare the received password with the password associated with the proxy scan job. If the received password is same as of the password associated with the proxy scan job, the instructions 612 may cause the processing resource 604 to execute the proxy scan job to scan a document. The instruction 612 may further cause the processing resource 604 to transmit the scanned to the contact identifier.

In an example, the instruction 612 may cause the processing resource 604 to print the scanned document. In an example, a user may provide an instruction to print the scanned document and in response to the receiving the instruction, the instruction 612 causes the processing resource to print the scanned document. While printing the scanned document, the instruction 612 may cause the processing resource 604 to include an indication of the contact identifier in the printed document. For example, if the contact identifier is an email, say ryan@domainname.com, the instruction 612 may cause the processing resource 604 to include an indication in the printed document that the printing operation is performed in tandem with a scan operation performed further to a scan request initiated by ryan@domainname.com.

Thus, the methods and devices of the present subject matter provides techniques for securely scanning of the document. Although implementations of scanning of document have been described in a language specific to structural features and/or methods, it is to be understood that the appended claims are not necessarily limited to the specific features or methods described. Rather, the specific features and methods are disclosed as example for remote scanning of a document.

1. An imaging device comprising:
a communication engine to:
receive a scan request, the scan request comprising a contact identifier of a user;
create a proxy scan job corresponding to the scan request, the proxy scan job having a scan job identifier;
generate a password associated with the scan job identifier;
provide the scan job identifier to the contact identifier; and
send the password to the contact identifier, and
a scan engine to:
execute the proxy scan job to scan a document, upon receiving, as a user input, the password corresponding to the scan job identifier; and
send the scanned document to the contact identifier.

2. The imaging device as claimed in claim 1, wherein the scan engine is to:
allow selection of the proxy scan job from amongst a plurality of proxy scan jobs based on the scan job identifier.

3. The imaging device as claimed in claim 1, further comprising a print engine to:
print the scanned document; and
insert an indication of the contact identifier in the printed document.

4. The imaging device as claimed in claim 1, wherein the scan request is an email directed to an email address associated with the imaging device, the email comprising a read receipt.

5. The imaging device as claimed in claim 1, wherein the scan request is an email directed to an email address associated with the scan engine of the imaging device.

6. The imaging device as claimed in claim 1 further comprising an authentication engine to:
determine, based on the contact identifier associated with the scan request, whether the imaging device is authorized to accept the scan request, wherein the proxy scan job is created based on the determination; and
authenticate the password received as the user input.

7. A method comprising:
sending a scan request to a server, wherein the scan request is for scanning a document by an imaging device, the scan request comprising a contact identifier of a user;
receiving, in response to the sending of the scan request, a password associated with the scan request from the server; and
receiving, via the contact identifier, scan data associated with the scan request upon the password being provided to the imaging device.

8. The method as claimed in claim 7, wherein the scan request is sent to the server associated with the imaging device, the scan request being directed to an email address associated with the imaging device.

9. The method as claimed in claim 8, wherein the scan request is an email comprising a read receipt to indicate to a scanning function of the imaging device.

10. The method as claimed in claim 7, wherein the contact identifier is an email address associated with the user.

11. A non-transitory computer-readable medium comprising instructions executable by a processing resource to:
receive a scan request from a contact identifier;
create a proxy scan job corresponding to the scan request;
generate a password for the proxy scan job; and
transmit the password to the contact identifier.

12. The non-transitory computer-readable medium as claimed in claim 11, comprising instructions executable by the processing resource to:
receive the password as a user input;
execute, in response to receiving the password, the proxy scan job to scan a document; and
transmit the scanned document to the contact identifier.

13. The non-transitory computer-readable medium as claimed in claim 12, comprising instructions executable by the processing resource to:
print the scanned document; and
insert an indication of the contact identifier in the printed document.

14. The non-transitory computer-readable medium as claimed in claim 11, comprising instructions executable by the processing resource to:
create the proxy scan job by generating a scan job identifier, and
associate the password with the scan job identifier.

15. The non-transitory computer-readable medium as claimed in claim 14, comprising instructions executable by the processing resource to:
allow selection of the proxy scan job from amongst a plurality of proxy scan jobs based on the scan job identifier; and
compare the password received as user input with the password associated with the scan job identifier to execute the proxy scan job.
